(19) United States
(12) Patent Application Publication
(10) Pub. No.: US 2014/0033172 A1
(43) Pub. Date: Jan. 30, 2014

(54) CONFIGURATION OF WIDGETS IN A MASHUP ENVIRONMENT

(71) Applicant: INTERNATIONAL BUSINESS MACHINES CORPORATION, Armonk, NY (US)

(72) Inventors: Andrew A. ARMSTRONG, Chandlers Ford (GB); Simon E. BURNS, Eastleigh (GB); Jonathan C. MACE, Providence, RI (US)

(21) Appl. No.: 13/943,450

(22) Filed: Jul. 16, 2013

(30) Foreign Application Priority Data
Jul. 26, 2012 (GB) 1213298.1

(51) Int. Cl. G06F 9/44

(52) U.S. Cl. CPC G06F 8/71
USPC 717/121

(57) ABSTRACT

A method, system, and/or computer program product configures widgets in a mashup environment. The mashup environment comprises a first widget having a first configuration. In response to an addition of a second widget to the mashup environment, where the second widget has a second configuration, a determination is made as to whether the first widget is related to the second widget by examining interaction relationship information between the first configuration and the second configuration. The first configuration to the second configuration are compared, and in response to determining that the first widget is related to the second widget and that the first configuration and the second configuration are different, the first configuration and/or the second configuration are updated in order to make them match one another.

This application is based on and claims the benefit of priority from United Kingdom Patent Application 1213298.1, filed on Jul. 26, 2012, and herein incorporated by reference in its entirety.

### BACKGROUND

The present invention relates to a method of configuring software applications and components, and in particular to configuring widgets in a mashup environment, such as a Web 2.0 environment.

In an application development environment, a mashup is a composite application that is operable to integrate and present data and functionalities that are provided by different sources. The basic component of a mashup is commonly referred to as a “widget”.

A “widget” is a self-contained reusable software application or component for creating or executing a task, or a piece of dynamic content. Widgets can be combined within mashups and can communicate with other applications or widgets. A widget is typically implemented as a functional user interface component such as a graphical user interface (GUI) object.

Widgets can communicate with each other using connectors known as “wires”. A wire has a source widget and one or more target widgets. Each widget may have a list of events that it can send and a list of events it can receive. A wire can connect an event that the source widget sends to an event that the target widget receives. The target widget can then do whatever actions it has defined for the target event.

Web 2.0 environments allow users to generate content for interaction and viewing by other users on the World Wide Web. In widget-based Web 2.0 environments, such as Lotus® Mashups and Business Space (both available from IBM® Corporation) (Lotus and IBM are registered trademarks of International Business Machines Corporation), widgets providing specific functions can be added to a page to produce mashups. Widgets can interact with other widgets by passing events to each other.

Widgets can be highly configurable, particularly when being used with highly configurable products such as enterprise-level software. Widgets that are to be provided in a particular product are likely to have similar aspects to configure or to be able to understand similar data.

### SUMMARY

A method, system, and/or computer program product configures widgets in a mashup environment. The mashup environment comprises a first widget having a first configuration. In response to an addition of a second widget to the mashup environment, where the second widget has a second configuration, a determination is made as to whether the first widget is related to the second widget by examining interaction relationship information between the first configuration and the second configuration. The first configuration to the second configuration are compared, and in response to determining that the first widget is related to the second widget and that the first configuration and the second configuration are different, the first configuration and/or the second configuration are updated in order to make them match one another.

### BRIEF DESCRIPTION OF THE SEVERAL VIEWS OF THE DRAWINGS

Preferred embodiments of the present invention will now be described, by way of example only, with reference to the following drawings in which:

FIG. 1 is a system within which one or more embodiments of the invention may be implemented;

FIG. 2 is simplified view of a mashup that may be used in the system of FIG. 1;

FIG. 3 is a flow diagram showing a method that may be carried out in one or more embodiments of the invention;

FIG. 4 is a schematic representation of a system architecture in which the present invention can be implemented; and

FIG. 5 is a method that may be carried out in another embodiment of the invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (comprising firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would comprise the following: an electrical connection having one or more wires, a portable computer diskette, a hard disk, a random access memory (RAM), a read-only memory (ROM), an erasable programmable read-only memory (EPROM or Flash memory), an optical fibre, a portable compact disc read-only memory (CD-ROM), an optical storage device, a magnetic storage device, or any suitable combination of the foregoing. In the context of this document, a computer readable storage medium may be any non-transitory tangible medium that can contain, or store a program for use by or in connection with an instruction execution system, apparatus, or device.

Computer program code for carrying out operations for aspects of the present invention may be written in any combination of one or more programming languages, comprising an object oriented programming language such as Java (Java and all Java-based trademarks and logos are trademarks or registered trademarks of Oracle and/or its affiliates), Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, comprising a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture comprising instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The various embodiments described herein may be implemented as a computer implemented method, system or computer program product.

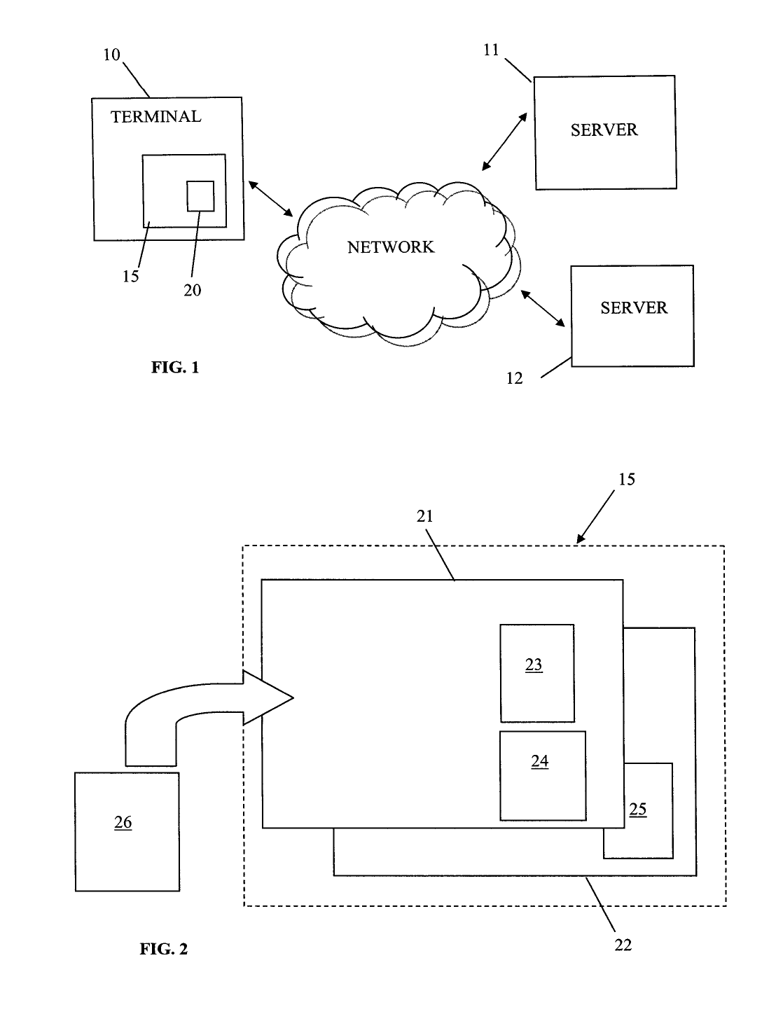

FIG. 1 shows an environment within which one or more embodiments of the invention may be implemented. A system comprising a user terminal 10 may be connected through a network to one or more servers 11, 12. The servers 11, 12 may be located remotely to the user terminal 10. The network may be any type of network such as an intranet within an organization and/or the Internet. The servers 11, 12 may provide access to data for use in one or more applications at the terminal 10. The terminal 10 may comprise a processing means, memory, storage means, input means and display means (not shown). The user terminal 10 can be an electronic device such as a computer and may be portable such as a laptop or tablet personal computer comprising touch sensitive areas to receive inputs to control the operation of the terminal.

In such a terminal 10, an application development environment is provided to enable an application to be developed by a user. The application development environment could be an application program that is initiated by a user and provides a graphical user interface for interaction with a user.

In an embodiment, such an application development environment is a mashup 15. The mashup 15 can comprise a mashup controller 20 to control the development of the mashup. The mashup controller 20 may be a software component within an application development framework, which can handle automatic configuration on behalf of multiple widgets, examining the closeness of any added widgets to existing widgets, and then deciding which settings to use. Alternatively, each widget may have its own integral controller implementing an identification of interaction relationships and/or a self-determination of which settings to reuse from other widgets.

Referring now to FIG. 2 which shows a simplified view of the mashup 15, the mashup 15 can comprise a number of pages 21, 22 each having its own graphical user interface. Each page 21,22 may contain a number of existing widgets. In this embodiment, a first page 21 comprises a first existing widget 23 representing a first type of widget application, and a second existing widget 24 representing a second type of widget application. A second page 22 of the mashup 15 may contain a third existing widget 25 representing a third type of widget application. The second page 22 can be accessed by any appropriate procedure such as a user selecting a tab (a graphical user interface object) representing the second page on the first page 21 of the mashup 15.

In one embodiment, the existing widgets 23, 24, 25 may each represent an application program, a piece of dynamic content or another software component, for creating or executing a task which has a particular functionality (same or different to each other) that can be provided to the user using the graphical user interface of the mashup 15. They can be graphical user interface components that can provide visualization to the user and/or a service to the page with which they are associated. One or more of the widgets 23, 24, 25 may be running in the background and not visible to the user via the graphical user interface.

In one embodiment, each widget 23, 24, 25 has its own configuration which comprises information relating to its interaction with other widgets (i.e., the widget may comprise events that are wired to other widgets). For example, widget 23 (i.e., a source widget) may comprise a list of events that it can send, which comprises a first event indicating that a task has been completed and which is wired to widget 24 (i.e., a target widget). Widget 24 may comprise a second event associated with the other end of the wire. The widget 24 may display a list of tasks.

The second event may be a refresh event such that when a task complete event is sent to the widget 24, a refresh event is carried out to update the task list displayed in the widget 24. This is one example of the type of interaction information that may exist in the widgets 23, 24, 25.

In the mashup 15, it is possible for new widgets to be added. Conventionally, new widgets would need to be manually configured to enable interoperability with any compatible existing widgets 23, 24, 25.

In an embodiment, the addition of a new widget to the mashup can cause self-configuration of the widgets based on the configuration of other widgets. The manner in which this is achieved will now be explained with reference to FIGS. 1-2.

Referring to FIG. 2, a new widget 26 is to be added to the first page 21 of the mashup 15. This can be achieved by carrying out a procedure to edit the first page 21 of the mashup 15. Upon receipt of an input relating to the desire to add a widget, the mashup controller 20 (shown in FIG. 1) generates a predetermined list of possible widgets to be added to the first page 21. A user may provide an input which causes the new widget 26 to be selected from the list and dragged to a particular area on the mashup in which the new widget 26 is to be located.

In one embodiment, the new widget 26 is of the type that is compatible with and can be recognized by the mashup 15. The new widget 26 comprises a default configuration which may comprise information of other widgets it is to interact with. The default configuration may not be the same as the configuration of the existing widgets 23, 24, 25 but may have some similarities. One example of a configuration comprises an XML descriptor with optional JavaScript and HTML resources.

Using the interaction information, depending on the chosen implementation, it is possible for either the widget 26 or a mashup controller 20 to determine which existing widgets 23, 24, of the current page 21, the new widget is related to. In an embodiment in which widgets are self-determining, the new widget 26 can examine the interaction relationships with other existing widgets 23, 24. The new widget 26 may also search for widgets on other pages such as widget 25 on the second page 22.

The closeness of the relationship between the new widget 26 and the existing widgets 23, 24, 25 can be determined using the interaction information. On the basis of the closeness, it is decided whether to examine other parts of the configuration of any of the existing widgets 23, 24, 25 and whether to update the configuration of the new widget 26 on the basis of the configuration of the examined existing widgets 23, 24, 25. It is possible for all elements of a set of widgets' configurations to be compared.

In an embodiment, the interaction information could be based on the number of events wired or the number of places where the event is wired/fired from. If the new widget 26 and existing widget 23 reference the same existing widget 24, 25, this could be an indication of closeness of interaction information. Another indication of closeness could be based on the number of wires one widget has to another widget. More than one wire can exist between two widgets. For example, if the existing widget 23 has four wires to the new widget 26 and the existing widget 24 has one wire to the new widget 26, this could be an indication that the existing widget 23 is closer to the new widget 26 than the existing widget 24.

After it has been established which of the existing widgets 23, 24, 25 are related to the new widget 26, the mashup controller 20 examines or parses the configuration of the closely related widgets to determine whether there are any relevant settings for the new widget 26. This can be achieved by looking for patterns in the configuration of the existing widget or similar keywords or types of data between the closely related existing widgets 23, 24, 25 and new widget 26. The presence of relevant settings will lead to the configuration of the new widget 26 being updated.

In an embodiment, the configuration of one or more of the closely related existing widgets 23, 24, 25 can be altered by the addition of the new widget 26 in the case where there is a functional link between the new widget 26 and one or more closely related widgets 23, 24, 25, such that the presence of the new widget 26 can enable this function in the existing widget(s).

In one embodiment, one or more of the existing widgets 23, 24, 25 and new widget 26 are standard iWidgets which comprise a configuration conforming to a specification that defines a standard way to wrap content and allow the content to participate in a mashup environment. In the case of an Midget configuration, the configuration of the widget 26 and the one or more of the existing widgets 23, 24, 25, 26 is based on a set of configuration options where each option is a name/value pair. If any of the configuration options in the closely related existing widgets 23, 24, 25 have the same name as options in the new widget 26, the mashup controller 20 will cause a value to be applied to that option in the configuration of the new widget 26.

In another embodiment, one or more of the existing widgets 23, 24, 25 and new widget 26 have configurations which comprise structured data conforming to JavaScript™ Object Notation (JSON). The mashup controller 20 can look for the relevant configuration within the structured data. The new widget 26 will have a default configuration and, using this, the mashup controller 20 can look for settings in the configuration of the closely related existing widgets 23, 24, 25 that may have the same name as the settings in the default configuration. In addition or alternatively, synonyms and/or antonyms may be analyzed.

An example of the processing that may be carried out in this embodiment which has configurations with structured data is explained below.

The new widget 26 may comprise the default settings in its configuration file of:

```
renderOptions:
      [{“http://CompanyA.com/myType1”: {visible: true, custom: false},
      {“http://CompanyA.com/myType2”: {visible: true, custom: false}]
```

The mashup controller 20 will examine one of the closely related widgets 23, 24, 25 and it may find the following section from the configuration associated with the closely related widget:

```
displaySettings:
    [{“http://CompanyA.com/myType1”: {visible: true, readonly: false},
    {“http://CompanyA.com/myType2”: {visible: false, readonly: false}]
```

The mashup controller 20 finds that one of the closely related widgets 23, 24, 25 has settings for objects “http://companyA.com/myType1” and “http://companyA.com/myType2”. Comparing the values, it finds that both the default settings and the settings in the closely related widget have a “visible” setting for each object type. It can use these “visible” settings to override the default settings in the configuration of the new widget such that the settings are updated to:

```
renderOptions:
      [{“http://CompanyA.com/myType1”: {visible: true, custom: false},
      {“http://CompanyA.com/myType2”: {visible: false, custom: false}]
```

The “visible” setting along with its associated value can be considered a name or key and value pair with the name/key being “visible” and the value being “true” or “false”. Names/keys that do not match, such as “readonly” in this case, are ignored.

It will be appreciated that different values may be associated with a particular name/key and the embodiment is not restricted to Boolean values of true or false. The values could be any number of types such as a number or string.

It will also be appreciated that the reference to a mashup controller 20 is intended to identify the processing that occurs in the mashup environment and the implementation of the mashup controller 20 may be through software or hardware. Instead of providing a mashup controller 20, the widgets themselves could provide the functionality of the mashup controller 20.

Although a number of existing widgets have been described when referring to FIG. 2, it will be appreciated by the skilled person that one or more existing widgets may be present in the mashup environment.

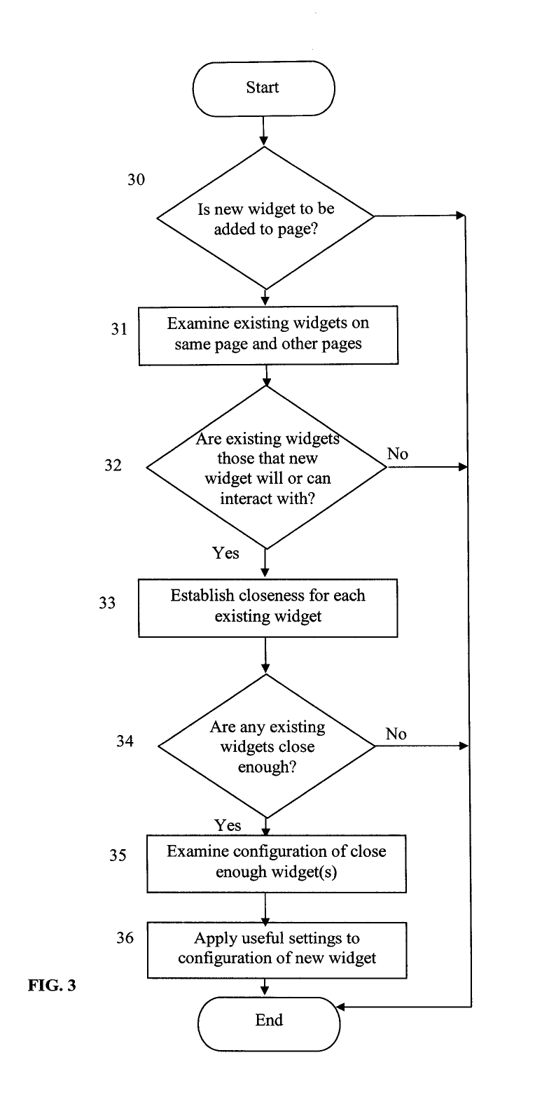

An embodiment of the method that may be carried out in the terminal 10 will now be described with reference to FIG. 3 by using reference numerals of the widgets of FIG. 2. The method may be implemented in code to accomplish the aforementioned results.

After initiator block 29, a determination (step 30) is made on whether a new widget 26 is to be added to a page in the mashup. This could be through a user selecting a function to add a widget on the mashup. Other existing widgets on the same page and other pages of the mashup are examined (step 31). It can then be determined whether any of the existing widgets on the same page will interact with the new widget 26 and whether any of the existing widgets on other pages could interact with the new widget 26 even if the new widget 26 does not actually interact with the existing widgets on the other pages (step 32). Based on the interaction information, a closeness of relationship is established between the new widget and each existing widget that the new widget 26 will or can interact with and a determination is made of whether these existing widgets are sufficiently closely related to the new widget (step 33) to justify automatic configuration of the new widget based on an existing widget. In a first embodiment, if a first widget A has three events wired to widget B and one event wired to widget C, Widget A is closer to B than to C. However, the determination of closeness of relationships does not need to be limited to checking the number of wired events. In an alternative embodiment, the importance of a particular event to a widget is assessed. For example, if widget A makes frequent use of an event wired to widget C (e.g. triggers event from many places or simply triggers a lot), then A may be considered close to C.

In various embodiments of the invention, potential interactions between widgets and/or other matching patterns or characteristics and other relationships between widgets are identifiable by the mashup controller in order to assess the closeness of the relationship, and a comparison of this closeness factor with a predetermined threshold can be made. Only those existing widgets with a closeness factor equal to or above the predetermined threshold are considered close enough to justify automatic configuration of the new widget based on an existing widget.

For those existing widgets that are considered close enough (step 34), the detailed configuration of the widgets is examined (step 35). If there are any useful settings in the configuration of the close enough existing widgets, these are applied to the new widget 26 (step 36). The process ends at terminator block 37.

It will be appreciated that the determination in step 32 could occur separately or simultaneously. That is, the existing widgets on the same page could be checked to determine if the new widget 26 interacts with them and then the existing widgets on the other pages could be checked to determine if the new widget 26 could interact with them. Alternatively, this could be carried out simultaneously. In one embodiment, the check for existing widgets on other pages is simply not carried out.

In the simple case, such as in the case of standard iWidgets where the configuration of widgets is based on a set of configuration options (e.g. where each option is a name/value pair), the widget controller examines the configuration options in closely related widgets. If any of the configuration options have the same name as options in the new widget, the value is applied to that option in the new widget.

Different existing widgets can supply different parts of the configuration for a new widget. For example, if there are several widgets that are identified as having a sufficiently close interaction, they can provide settings for different parts of the configuration. In the current embodiment, if there is a conflict between the configuration information of a number of widgets that are identified as having a close relationship to a new widget, then the closest widget's configuration is used. If there is a conflict between the configuration between equally close widgets, then the widget that is providing the most configuration settings can be chosen. If two or more existing widgets are determined to be equally close and provide the same number of reusable settings, then it is possible to select either one of the existing widgets to provide configuration information for the new widget.

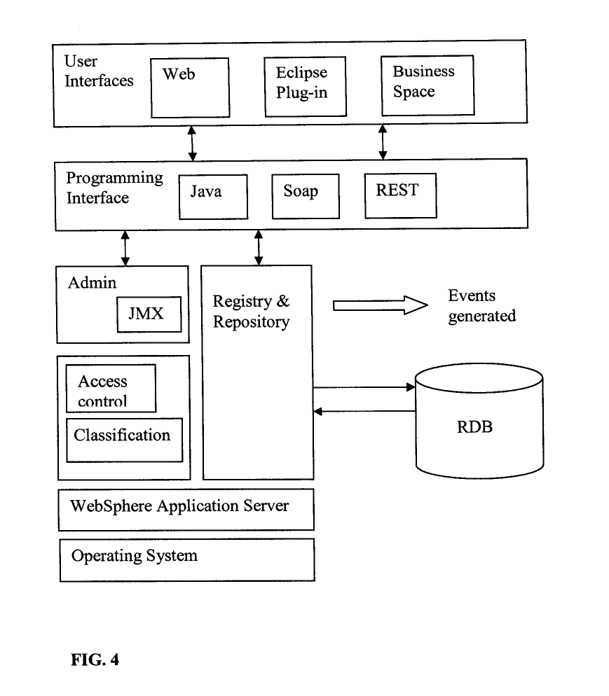

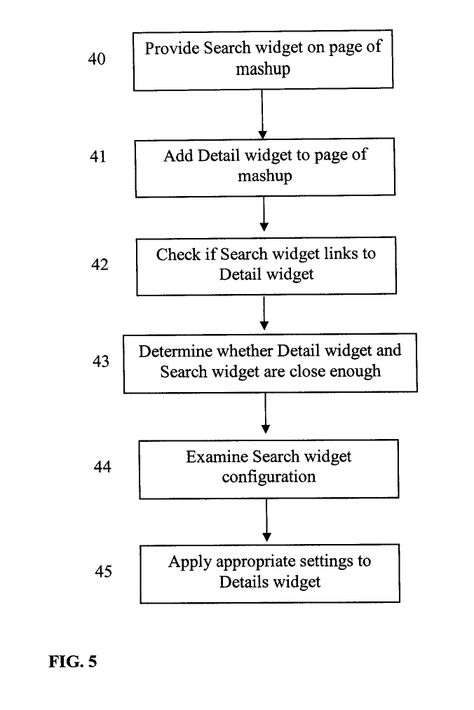

An embodiment will now be provided with reference to FIG. 4 and FIG. 5 and in the particular context of the IBM® WebSphere® (WebSphere is a registered trademark of International Business Machines Corporation) Service Registry and Repository (WSRR) and the Business Space user interface that provides a mashup environment.

An exemplary system architecture is shown schematically in FIG. 4. IBM's WSRR provides service registry and repository functions for service-oriented software, and is available as a J2EE application running on IBM's WebSphere Application Server and using a relational database as a backing store. The WSRR product provides, in addition to metadata storage functions, update and retrieval functions supporting Create, Retrieve, Update, Delete and. Query capability for the service metadata stored in the relational database. In one embodiment, three user interfaces 400 are provided to access WSRR: a Web interface, an Eclipse plug-in and a Business Space user interface. The Business Space user interface is a browser-based graphical user interface providing a mashup environment allowing users to aggregate and interact with content, and allowing users to search and view details of data items in the registry and to perform other key tasks. Widgets are available in the Business Space environment as user interface components that can be aggregated to define the functionality of a particular Business Space mashup. The mashup framework can comprise a number of widgets such as those shown schematically in FIG. 2. One such widget may already exist on a page in the mashup. In this embodiment, the existing widget is a WSRR Search widget that may contain settings for determining which types are visible to the user. The WSRR Detail widget may contain settings for which relationships are visible to the user. A relationship is a link between objects.

The sequence of steps of this embodiment is shown in FIG. 5. After initiator block 39, the Search widget is provided on the page (step 40). The Detail widget is added to the page (step 41). The Detail widget discovers the Search widget already on the page, and finds that the Search widget links to the Detail widget (step 42). No other pages are provided in the mashup in this embodiment and therefore no searching of other pages is required. The Search Widget determines how close the relationship between it and the Detail widget is and judges that because the widgets are both for the same product (WSRR), one link between them is close enough and the closeness exceeds a predetermined level (step 43). The Detail widget examines the Search widget configuration which reveals that it contains settings for the visibility of types (step 44). Using the visibility of types settings, it applies them to the Detail settings for relationships, so that only relationships that point to visible types are visible—all other relationships are hidden (step 45). The process ends at terminator block 46.

In some embodiments, the mashup may be used to combine many different types of widgets (e.g., iWidget, WSRR widget, iGoogle™ widget). The configuration of the new widget would then be compared to the existing widgets and the procedure as already explained with reference to FIG. 3 can be followed to determine the closeness of the new widget with the existing widgets and whether updating of the configuration of the new widget is appropriate. In such an embodiment, widgets of the same type such as iWidgets would be identified as closer than widgets of different types.

As described herein, from a first aspect, an embodiment provides a method of configuring widgets in a mashup environment, comprising: (a) providing a mashup environment comprising a first widget having a first configuration; (b) responding to the addition of a second widget to the mashup environment, wherein the second widget has a second configuration, by determining whether the first widget is related to the second widget by examining interaction relationship information between the first and second configuration; and (c) determining whether the first and/or second configuration requires updating on the basis of the determination made in step (b) and a comparison between the first and second configurations.

This enables the widgets to be automatically configured after determining whether the widgets are closely related. In one embodiment, the method comprises a step (d) automatically performing required updating in response to a positive determination in step (c).

One embodiment of the present invention provides a system for configuring widgets in a mashup environment comprising a first widget having a first configuration, the system comprising: means, responsive to the addition of a second widget to the mashup environment, wherein the second widget has a second configuration, for determining whether the first widget is related to the second widget by examining interaction relationship information between the first and second configuration; and means for determining whether the first and/or second configuration requires updating on the basis of the examination of the interaction relationship information.

One embodiment of the present invention provides a mashup controller for configuring widgets in a mashup environment comprising a first widget having a first configuration, the controller being responsive to the addition of a second widget to the mashup environment, wherein the second widget has a second configuration, and adapted to determine whether the first widget is related to the second widget by examining interaction relationship information between the first and second configuration; and to determine whether the first and/or second configuration requires updating on the basis of the examination of the interaction relationship information.

One embodiment of the present invention provides a computer program product for configuring widgets in a mashup environment that comprises a first widget having a first configuration, the computer program product comprising a computer-readable storage medium having computer-readable program code embodied thereon, the computer-readable program code arranged to: (a) respond to the addition of second widget to the mashup environment, wherein the second widget has a second configuration by determining whether the first widget is closely related to the second widget by examining interaction relationship information between the first and second configuration; and (b) determine whether the first and/or second configuration requires updating on the basis of the determination made in step (a) and a comparison between the first and second configurations.

Note that the present invention allows developers and users to be able to incorporate widgets into the mashup environment efficiently, without requiring manual configuration of widgets each time a widget is added to the environment.

It will be appreciated by a person skilled in the art having the benefit of this disclosure that the embodiments described herein are not restricted for use with any particular application development environment. Rather, embodiments may be used on any electronic device having an environment which comprises widgets that can be configured to interact with each other.

In addition to the embodiments described in detail above, the skilled person will recognize that various features described herein can be modified and combined with additional features, and the resulting additional embodiments are also within the scope of the present invention. It will also be apparent to the skilled person that the embodiments described herein can be implemented not only by software running on an electronic device, but also by hardware logic components arranged appropriately.

What is claimed is:

1. A method of configuring widgets in a mashup environment, the method comprising:
providing, by one or more processors, a mashup environment, wherein the mashup environment comprises a first widget having a first configuration;
in response to an addition of a second widget to the mashup environment, wherein the second widget has a second configuration, determining, by one or more processors, whether the first widget is related to the second widget by examining interaction relationship information between the first configuration and the second configuration;
comparing, by one or more processors, the first configuration to the second configuration, and
in response to determining, by one or more processors, that the first widget is related to the second widget and that the first configuration and the second configuration are different, updating the first configuration and/or the second configuration to match one another.

2. The method of claim 1, further comprising:
determining, by one or more processors, which portions of the first configuration of the first widget are utilized by the second widget; and
applying, by one or more processors, the portions of the first configuration, which are determined to be utilized by the second widget, to the second configuration of the second widget.

3. The method of claim 1, further comprising:
identifying, by one or more processors, any matching patterns found in both the first configuration and the second configuration.

4. The method of claim 1, wherein the first configuration comprises a set of configuration objects having a predetermined format comprising a name and value for each object, and wherein the method further comprises:
identifying, by one or more processors, any names in both the first configuration and the second configuration that are identical.

5. The method of claim 1, wherein the first configuration comprises a set of configuration objects having a predetermined format comprising a name and value for each object, and wherein the method further comprises:
identifying, by one or more processors, any names in the first configuration and the second configuration that are similar according to predefined parameters.

6. The method of claim 1, wherein the first configuration comprises a set of configuration objects having a predetermined format comprising a name and value for each object, and wherein the method further comprises:
identifying, by one or more processors, any names in the first configuration and the second configuration that are similar according to whether synonyms of the names in the first configuration are present in the second configuration.

7. The method of claim 6, further comprising:
in response to making a determination that there is a similarity between said names, applying, by one or more processors, the value of said each object to the second configuration.

8. The method of claim 1, wherein the mashup environment comprises a plurality of widgets comprising the first widget, and wherein the method further comprises:
determining, by one or more processors, whether the second widget is related to any one of the plurality of widgets.

9. The method of claim 8, wherein the mashup environment comprises a plurality of graphical user interfaces, wherein the first widget is incorporated into one of the graphical user interfaces, wherein the remaining plurality of widgets are incorporated into another of the graphical user interfaces, wherein the method further comprises:
determining, by one or more processors, whether the second widget is related to any of the remaining plurality of widgets.

10. The processor-implemented method of claim 1, wherein the widgets are graphical user interface objects.

11. A system for configuring widgets in a mashup environment that comprises a first widget having a first configuration, the system comprising:
a central processing unit (CPU), a computer readable memory, and a computer readable storage media;
first program instructions to provide a mashup environment, wherein the mashup environment comprises a first widget having a first configuration;
second program instructions to, in response to an addition of a second widget to the mashup environment, wherein the second widget has a second configuration, determine whether the first widget is related to the second widget by examining interaction relationship information between the first configuration and the second configuration;
third program instructions to compare the first configuration to the second configuration, and
fourth program instructions to, in response to determining that the first widget is related to the second widget and that the first configuration and the second configuration are different, update the first configuration and/or the second configuration to match one another; and wherein the first, second, third, and fourth program instructions are stored on the computer readable storage media for execution by the CPU via the computer readable memory.

12. The system of claim 11, further comprising:
fifth program instructions to determine which portions of the first configuration of the first widget are utilized by the second widget; and
sixth program instructions to apply the portions of the first configuration, which are determined to be utilized by the second widget, to the second configuration of the second widget;
and wherein
the fifth and sixth program instructions are stored on the computer readable storage media for execution by the CPU via the computer readable memory.

13. The system of claim 11, further comprising:
fifth program instructions to identify any matching patterns found in both the first configuration and the second configuration; and wherein the fifth program instructions are stored on the computer readable storage media for execution by the CPU via the computer readable memory.

14. The system of claim 11, wherein the first configuration comprises a set of configuration objects having a predetermined format comprising a name and value for each object, and wherein the system further comprises:
fifth program instructions to identify any names in both the first configuration and the second configuration that are identical; and wherein
the fifth program instructions are stored on the computer readable storage media for execution by the CPU via the computer readable memory.

15. The system of claim 11, wherein the first configuration comprises a set of configuration objects having a predetermined format comprising a name and value for each object, and wherein the system further comprises:
fifth program instructions to identify any names in the first configuration and the second configuration that are similar according to predefined parameters; and wherein the fifth program instructions are stored on the computer readable storage media for execution by the CPU via the computer readable memory.

16. A computer program product for configuring widgets in a mashup environment, the computer program product comprising:
a computer readable storage media;
first program instructions to provide a mashup environment, wherein the mashup environment comprises a first widget having a first configuration;
second program instructions to, in response to an addition of a second widget to the mashup environment, wherein the second widget has a second configuration, determine whether the first widget is related to the second widget by examining interaction relationship information between the first configuration and the second configuration;
third program instructions to compare the first configuration to the second configuration, and
fourth program instructions to, in response to determining that the first widget is related to the second widget and that the first configuration and the second configuration are different, update the first configuration and/or the second configuration to match one another; and wherein the first, second, third, and fourth program instructions are stored on the computer readable storage media.

17. The computer program product of claim 16, further comprising:
fifth program instructions to determine which portions of the first configuration of the first widget are utilized by the second widget; and
sixth program instructions to apply the portions of the first configuration, which are determined to be utilized by the second widget, to the second configuration of the second widget; and wherein
the fifth and sixth program instructions are stored on the computer readable storage media.

18. The computer program product of claim 16, further comprising:
fifth program instructions to identify any matching patterns found in both the first configuration and the second configuration; and wherein
the fifth program instructions are stored on the computer readable storage media.

19. The computer program product of claim 16, wherein the first configuration comprises a set of configuration objects having a predetermined format comprising a name and value for each object, and wherein the computer program product further comprises:
fifth program instructions to identify any names in both the first configuration and the second configuration that are identical; and wherein
the fifth program instructions are stored on the computer readable storage media.

20. The computer program product of claim 16, wherein the first configuration comprises a set of configuration objects having a predetermined format comprising a name and value for each object, and wherein the computer program product further comprises:
fifth program instructions to identify any names in the first configuration and the second configuration that are similar according to predefined parameters; and wherein
the fifth program instructions are stored on the computer readable storage media.
